(19) United States
(12) Patent Application Publication
(10) Pub. No.: US 2026/0302907 A1
(43) Pub. Date: Oct. 1, 2026

(54) KEY MOTOR SYSTEM

(71) Applicant: AAC Microtech (Changzhou) Co., Ltd., Changzhou City (CN)

(72) Inventors: Wei Song, Changzhou (CN); Lubin Mao, Changzhou (CN)

(21) Appl. No.: 19/325,481

(22) Filed: Sep. 10, 2025

Related U.S. Application Data
(63) Continuation of application No. PCT/CN2025/084963, filed on Mar. 26, 2025.

(51) Int. Cl. H02K 33/12; H02K 11/215

(52) U.S. Cl. CPC H02K 33/12; H02K 11/215; H02K 2211/03

(57) ABSTRACT

The present disclosure discloses a key motor system, including: a housing being of a hollow structure; a vibrator assembly elastically supported in the housing; two stator assemblies spaced apart from the vibrator assembly and vibrating in a first direction, the two stator assemblies disposed on opposite sides of the vibrator assembly in a second direction, a side of each stator assembly away from the vibrator assembly being fixed to the housing, the second direction being perpendicular to the first direction; each stator assembly including a stator unit having an iron core fixed to the housing and a drive coil wound around the iron core; and at least two motor drive amplifier units respectively configured to drive the drive coil of one stator unit. Compared with related technologies, the key motor system of the present disclosures exhibits enhanced driving performance and reduced spatial occupation.

### CROSS REFERENCE TO RELATED APPLICATIONS

This application is a continuation of PCT Patent Application No. PCT/CN2025/084963, entitled “KEY MOTOR SYSTEM”, filed on Mar. 26, 2025, which is incorporated by reference herein in its entirety.

### TECHNICAL FIELD

The various embodiments described in this document relate in general to the field of key technology, and more specifically to a key motor system.

### BACKGROUND

A touch key is a key that senses a pressing signal to achieve touch control, specifically by sensing the pressed position and pressing force to accurately detect and achieve precise control.

The touch key mainly includes a housing, a motor fixed in the housing, and a key fixed to the motor. The motor mainly includes a stator and a vibrator, and the vibrator is elastically supported in the housing and spaced apart from the stator. The working principle of the touch key is that when the key is pressed, the vibrator generates displacement in the pressing direction, thereby achieving corresponding control by detecting the displacement amount and the position where displacement occurs.

In the related art, the stator of the motor includes a drive coil, and the vibrator includes a magnet. The vibrator is driven to move through mutual driving between the drive coil and the magnet. However, this motor uses an independent power amplifier chip to drive the drive coil. Limited by the power and current of a single amplifier, the motor power cannot be further increased, and the driving force can only be improved by increasing the device size. This results in low motor driving power and a large overall occupied space.

Therefore, it is necessary to provide a new key motor system to solve the above problems.

### SUMMARY

In some embodiments, a key motor system, includes: a housing, the housing being of a hollow structure, a vibrator assembly elastically supported in the housing, and two stator assemblies for driving the vibrator assembly to vibrate in a first direction and spaced apart from the vibrator assembly. The two stator assemblies are disposed on opposite sides of the vibrator assembly in a second direction, and a side of each of the two stator assemblies away from the vibrator assembly is fixed to the housing. The second direction is perpendicular to the first direction. Each of the two stator assemblies includes a stator unit, the stator unit includes an iron core fixed to the housing and a drive coil, and the drive coil is wound around the iron core. The key motor system further includes at least two motor drive power amplifier units, and each of the at least two motor drive power amplifier units is configured to drive the drive coil of one of the stator units.

In some embodiments, each of the two stator assemblies further includes a pole core, and the pole core is clamped and fixed between a corresponding one of the stator units and the housing.

In some embodiments, the key motor system further includes Hall sensors, each of the Hall sensors is fixed on a side of the pole core close to the vibrator assembly, and the Hall sensors are configured to collect motion data of the vibrator assembly and send the motion data to the motor drive power amplifier units.

In some embodiments, the key motor system further includes flexible circuit boards, an end of each of the flexible circuit boards away from the vibrator assembly is configured to connect to an external power source, an end of each flexible circuit board close to the vibrator assembly is fixed to the pole core; each of the Hall sensors is mounted on a corresponding one of the flexible circuit boards, and each of the flexible circuit boards is electrically connected to the corresponding Hall sensor and drive coil.

In some embodiments, each of the flexible circuit boards includes a circuit board body, a power connection portion extending from the circuit board body in a direction away from the housing, and a connection portion bent and extending from an end of the circuit board body close to the vibrator assembly in the first direction. The power connection portion is configured to connect to the external power source, the connection portion is fixed on a side of the pole core close to the vibrator assembly, and the Hall sensor is fixed to the connection portion.

In some embodiments, each of the two stator assemblies includes at least two stator units arranged side by side in a third direction. The first direction, the second direction, and the third direction are mutually perpendicular to each other. A quantity of the motor drive power amplifier units is consistent with a quantity of the stator units, and each of the motor drive power amplifier units is configured to drive the drive coil of one of the stator units.

In some embodiments, the flexible circuit board includes a first circuit board and a second circuit board oppositely disposed in the third direction, a third circuit board connecting the first circuit board and the second circuit board, and at least two avoidance holes penetrating through the third circuit board and spaced apart in the third direction. An end of each of the first circuit board and the second circuit board away from the stator unit is configured to connect to an external power source. The third circuit board is stacked and fixed to a side of the pole core close to the vibrator assembly. The iron core of each stator unit passes through one of the avoidance holes and is fixed to the pole core. The drive coil of each stator unit is stacked and fixed to a side of the third circuit board close to the vibrator assembly. The Hall sensors are fixed to the flexible circuit boards, and a quantity of the Hall sensors is consistent with the quantity of the stator units.

In some embodiments, the house includes two outer shells spaced apart from each other in the second direction, and two end covers spaced apart from each other in the third direction. The outer shells are fixed to a side of the stator assembly away from the vibrator assembly, and the vibrator assembly is elastically supported between the two end covers.

In some embodiments, the key motor system further includes two elastic components, an end of each of the elastic components away from the vibrator assembly is fixed to the end cover; and an end of each elastic component close to the vibrator assembly are respectively fixed to opposite ends of the vibrator assembly in the third direction.

In some embodiments, the elastic component includes a non-metallic elastic member fixed to a side of the end cover close to the vibrator assembly, and a connector member fixed to a side of the non-metallic elastic member close to the vibrator assembly. A side of the connector member away from the end cover is fixed to the vibrator assembly.

### BRIEF DESCRIPTION OF THE DRAWINGS

The embodiments of the present disclosure are illustrated by way of example and not limitation in the figures of the accompanying drawings, in which like references may indicate similar elements.

FIG. 1 is a schematic diagram illustrating a perspective structure of a key motor system in accordance with a first embodiment of the present disclosure.

FIG. 2 is a schematic diagram illustrating an exploded view of the key motor system in accordance with the first embodiment of the present disclosure.

FIG. 3 is a partial exploded schematic diagram of the key motor system in FIG. 2.

FIG. 4 is a cross-sectional view taken along line A-A of FIG. 1.

FIG. 5 is a cross-sectional view taken along line B-B of FIG. 1.

FIG. 6 is a schematic diagram illustrating a structure of a non-metallic elastic member of a key motor system according to the first embodiment of the present disclosure.

FIG. 7 is a schematic diagram illustrating a perspective structure of a key motor system in accordance with a second embodiment of the present disclosure.

FIG. 8 is a schematic diagram illustrating an exploded view of the key motor system in accordance with the second embodiment of the present disclosure.

FIG. 9 is a cross-sectional view taken along line C-C of FIG. 7.

### DETAILED DESCRIPTION OF THE EMBODIMENTS

The following will describe clearly and completely the technical solutions in the embodiments of the present disclosure in combination with the accompanying drawings. Obviously, the described embodiments are only a part of the embodiments of the present disclosure, not all of them. Based on the embodiments of the present disclosure, all other embodiments obtained by a person of ordinary skill in the art without making creative efforts shall fall within the scope of protection of the present disclosure.

### Embodiment 1

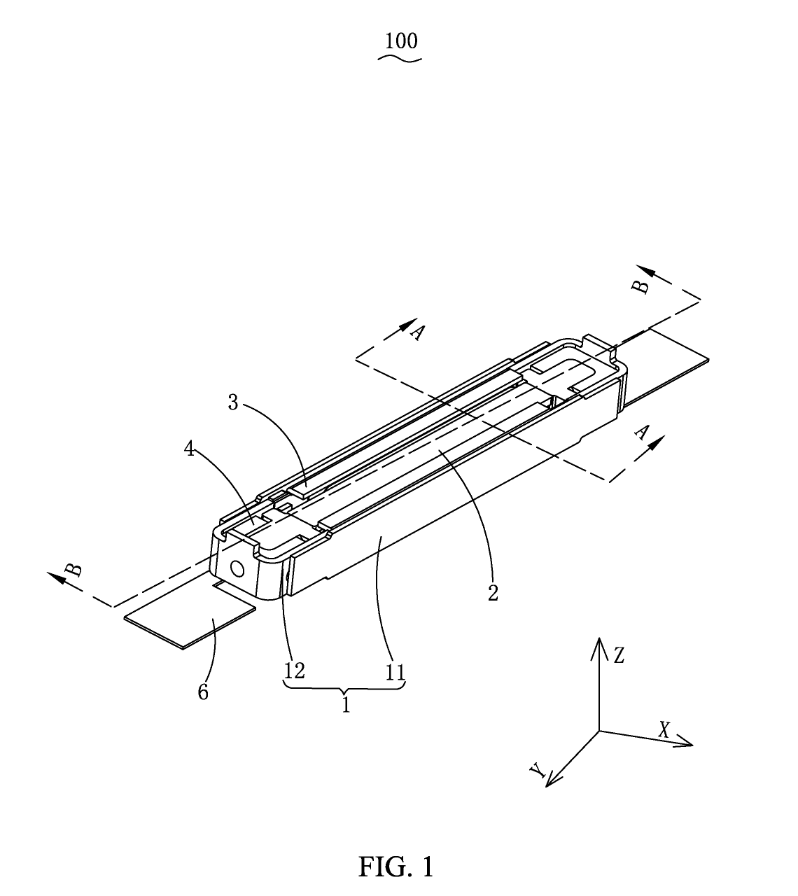

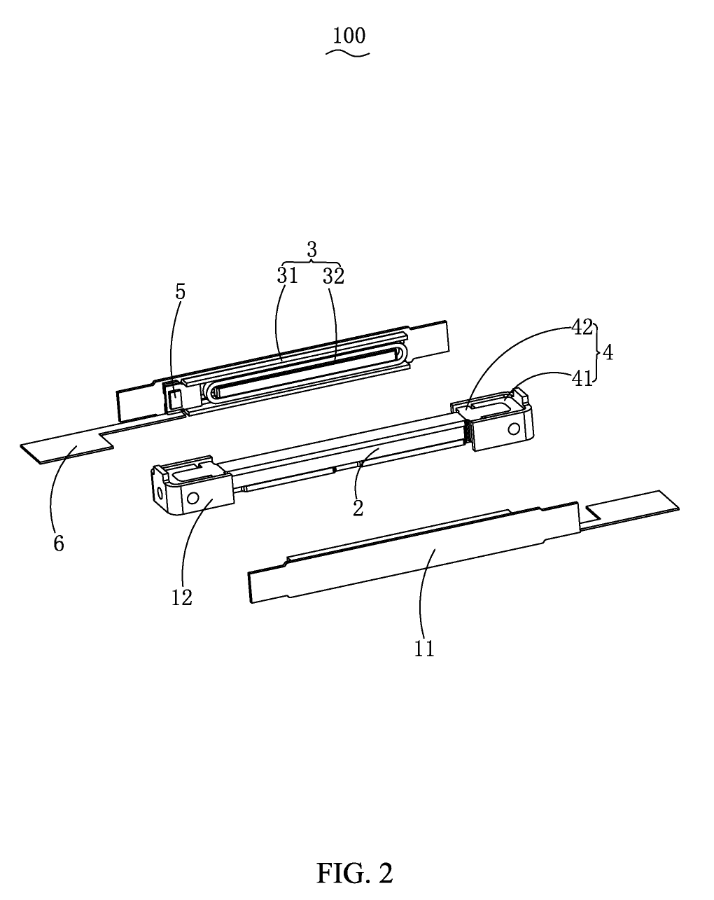

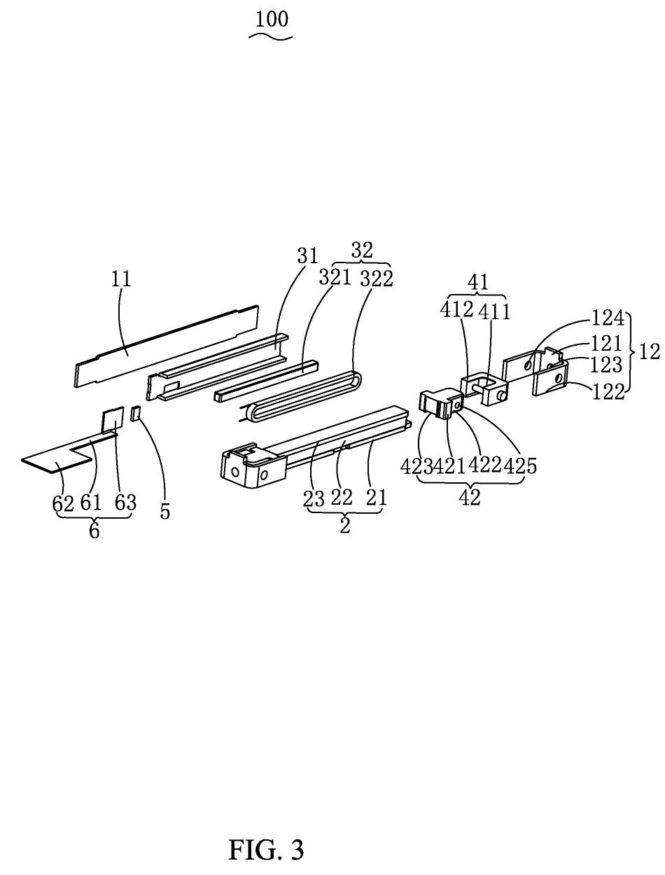

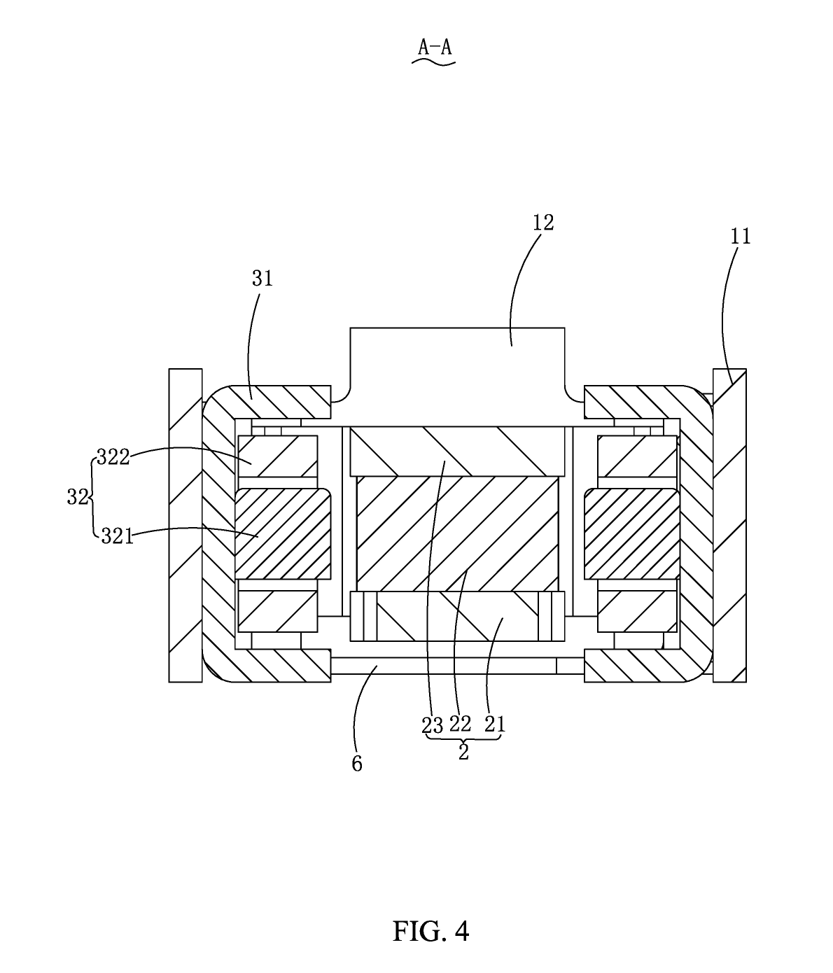

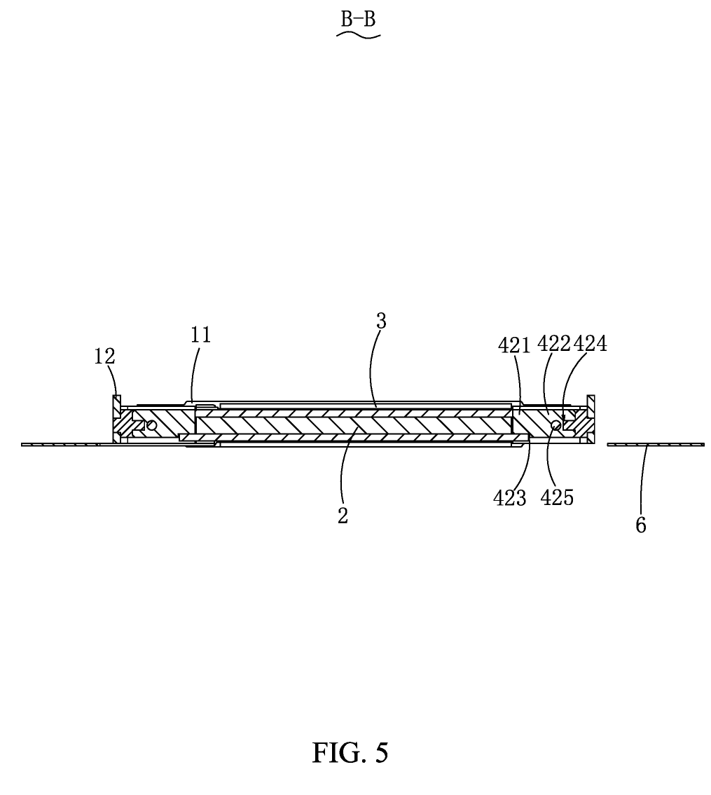

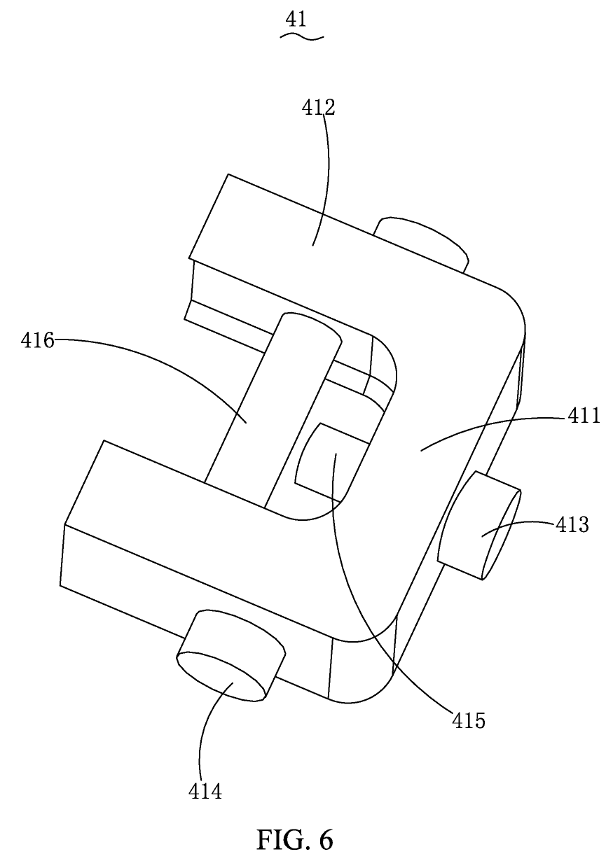

Please refer to FIGS. 1 to 6, an embodiment of the present disclosure provides a key motor system 100. The key motor system 100 includes a housing 1, a vibrator assembly 2, a stator assembly 3, and motor drive power amplifier units (not shown in the figures).

The housing 1 is of a hollow structure. The hollow structure is used to mount the stator assembly 3 and the vibrator assembly 2 therein. This configuration allows the component space to be further reduced, thereby avoiding interference with the overall device layout, especially the battery size.

The vibrator assembly 2 is elastically supported in the housing 1, facilitating the vibrator assembly 2 to receive driving feedback and achieve elastic movement while subjected to a pressing force from an external keycap.

The stator assembly 3 drives the vibrator assembly 2 to vibrate in the first direction. The stator assembly 3 is spaced apart from the vibrator assembly 2. The stator assembly 3 is designated as two. The two stator assemblies 3 are disposed on opposite sides of the vibrator assembly 2 in the second direction. A side of each stator assembly 3 away from the vibrator assembly 2 is fixed to the housing 1. The second direction is perpendicular to the first direction. Herein, the first direction is defined as the Z-axis direction, and the second direction is defined as the X-axis direction.

Each of the stator assemblies 3 includes a stator unit 32 fixed to a side of the housing 1 adjacent to the vibrator assembly 2.

In this embodiment, each of the stator assemblies 3 further includes a pole core 31, and the pole core 31 is clamped and fixed between the stator unit 32 and the housing 1. The pole core 31 enhances the overall magnetic field performance of the stator unit 32. The stator unit 32 includes an iron core 321 stacked and fixed to a side of the pole core 31 close to the vibrator assembly 2, and a drive coil 322. The drive coil 322 is wound around the iron core 321.

The motor drive power amplifier units are designated as at least two. Each of the at least two motor drive power amplifier units is used to drive the drive coil 322 of a corresponding one of the stator units 32. By establishing a one-to-one correspondence between the motor drive power amplifier units and the drive coils 322, the total driving force can be increased through enhanced drive power, resulting in stronger vibration output and improved user experience.

In this embodiment, the key motor system 100 further includes Hall sensors 5. Each Hall sensor 5 is fixed on a side of the pole core 31 (of a corresponding stator assembly 3) close to the vibrator assembly 2. The Hall sensors 5 are configured to collect motion data of the vibrator assembly 2 and send the motion data to the motor drive power amplifier units.

Specifically, when a keycap is pressed, the vibrator assembly 2 displaces in the first direction. The Hall sensors 5 on both sides of the vibrator assembly 2 detect the displacement of the vibrator assembly 2. The displacement data transmitted by the Hall sensors 5 is analyzed by a Hall chip of the key motor system 100 and uploaded to a main control IC chip. The control IC chip determines the pressing mode to implement the operation of the entire device and generates a feedback signal. This feedback signal is transmitted to the motor drive power amplifier units. Through independent power amplifiers of the motor drive power amplifier unit driving independent drive coils 322, the motor drive power increases, the vibration output is enhanced, and the user experience is improved.

In this embodiment, the key motor system 100 further includes flexible printed circuit boards 6. An end of each flexible printed circuit board 6 away from the vibrator assembly 2 is configured to connect to an external power source, and an end of each flexible printed circuit board 6 close to the vibrator assembly 2 is fixed to the pole core 31 (of a corresponding stator assembly 3). The Hall sensors 5 are respectively mounted on a corresponding one of the flexible printed circuit boards 6, and each flexible printed circuit board 6 is electrically connected to the corresponding Hall sensor 5 and drive coil 322 respectively. Each flexible printed circuit board 6 is configured to supply power to the corresponding Hall sensor 5 and drive coil 322. The motor drive power amplifier unit drives the energized drive coil 322 to increase the overall drive power of the motor, thereby enhancing the driving force. The flexible printed circuit boards 6 are respectively connected to one of the two stator assemblies 3 and extend in directions away from each other. Alternatively, the two flexible printed circuit boards 6 may be arranged opposing each other, and the installation position of the flexible printed circuit board 6 is not limited.

In this embodiment, the flexible printed circuit board 6 includes a circuit board body 61, a power connection portion 62 extending from the circuit board body 61 in a direction away from the housing 1, and a connection portion 63 bent and extending from an end of the circuit board body 61 close to the vibrator assembly 2 in the first direction. The power connection portion 62 is configured to connect to the external power source. The connection portion 63 is fixed to a side of the pole core 31 close to the vibrator assembly 2. The Hall sensor 5 is fixed to the connection portion 63. By fixing the connection portion 63 to the pole core 31, it facilitates the mounting arrangement of the Hall sensor 5 and enables electrical connection with lead wire connections of the drive coil 322.

In this embodiment, the housing 1 includes two outer shells 11 spaced apart from each other in the second direction, and two end covers 12 spaced apart from each other in a third direction. The outer shells 11 are fixed to a side of the stator assembly 3 away from the vibrator assembly 2, and the vibrator assembly 2 is elastically supported between the two end covers 12. The pole core 31 is fixed to a side of the outer shell 11 close to the vibrator assembly 2. The second direction and the third direction lie in the same plane and are perpendicular to each other, while the first direction is perpendicular to both the second direction and the third direction. The third direction is defined as the Y-axis direction. Optionally, the outer shells 11 and the end covers 12 may be configured as an integrally formed structure, thereby providing high structural strength.

In this embodiment, the key motor system 100 further includes two elastic components 4. An end of each elastic component 4 away from the vibrator assembly 2 is fixed to the end cover 12, while an end of each elastic component 4 close to the vibrator assembly 2 is respectively fixed to opposite ends of the vibrator assembly 2 in the third direction. The stator assembly 3 drives the vibrator assembly 2 to move reciprocally in the first direction, and the two elastic components 4 enable the vibrator assembly 2 to achieve optimal vibration feedback during movement.

In this embodiment, the elastic component 4 includes a non-metallic elastic member 41 fixed to a side of the end cover 12 close to the vibrator assembly 2, and a connection member 42 fixed to a side of the non-metallic elastic member 41 close to the vibrator assembly 2. A side of the connection member 42 away from the end cover 12 is fixed to the vibrator assembly 2.

Optionally, the non-metallic elastic member 41 may be made of silicone, rubber, or similar materials. The non-metallic elastic member 41 and the connection member 42 may be configured as an integrally formed structure.

In this embodiment, the end cover 12 includes an end cover body 121, two fixing portions 122 bent and extending from opposite ends of the end cover body 121 toward the vibrator assembly 2, a first fixing hole 123 penetrating through the end cover body 121, and two second fixing holes 124 respectively penetrating through the two fixing portions 122.

The non-metallic elastic member 41 includes an elastic member body 411, two mounting plates 412 bent and extending from opposite ends of the elastic member body 411 toward the vibrator assembly 2, a first fixing post 413 protruding from the elastic member body 411 and extending away from the vibrator assembly 2, two second fixing posts 414 protruding respectively from the two mounting plates 412 and extending toward the two fixing portions 122, a third fixing post 415 protruding from the elastic member body 411 and extending toward the vibrator assembly 2, and a fourth fixing post 416 formed by the two mounting plates 412 extending towards each other. The first fixing post 413 is disposed in the first fixing hole 123, and the second fixing posts 414 are disposed in the second fixing holes 124.

The connection member 42 includes a connection member body 421, a mounting portion 422 extending from a side of the connection member body 421 away from the vibrator assembly 2 and toward the end cover 12, a first recess 423 concavely formed in the connection member body 421 along the first direction, a second recess 424 concavely formed inward from a side of the mounting portion 422 adjacent to the non-metallic elastic member 41, and a third fixing hole 425 penetrating through the mounting portion 422 along an extending direction of the fourth fixing post 416. The vibrator assembly 2 is fixed in the first recess 423, the third fixing post 415 is disposed in the second recess 424, and the fourth fixing post 416 is disposed in the third fixing hole 425.

In this embodiment, the vibrator assembly 2 includes a lower clamping plate 21, a magnetic steel 22 stacked and fixed on the lower clamping plate 21, and an upper clamping plate 23 stacked and fixed on the magnetic steel 22. The lower clamping plate 21 is fixed to a side of the connection member 42 away from the first direction. The drive coil 322 and the magnetic steel 22 generate magnetic fields to mutually drive each other, thereby driving the magnetic steel 22 to move along the first direction. The lower clamping plate 21 is configured to support and fix the magnetic steel 22 and the upper clamping plate 23. Meanwhile, the upper clamping plate 23 and the lower clamping plate 21 further provide magnetic permeability enhancement for the magnetic steel 22, thereby increasing the magnetic force of the vibrator assembly 2 and enabling the stator assembly 3 to drive the vibrator assembly 2 to achieve optimal vibration feedback during movement.

### Embodiment 2

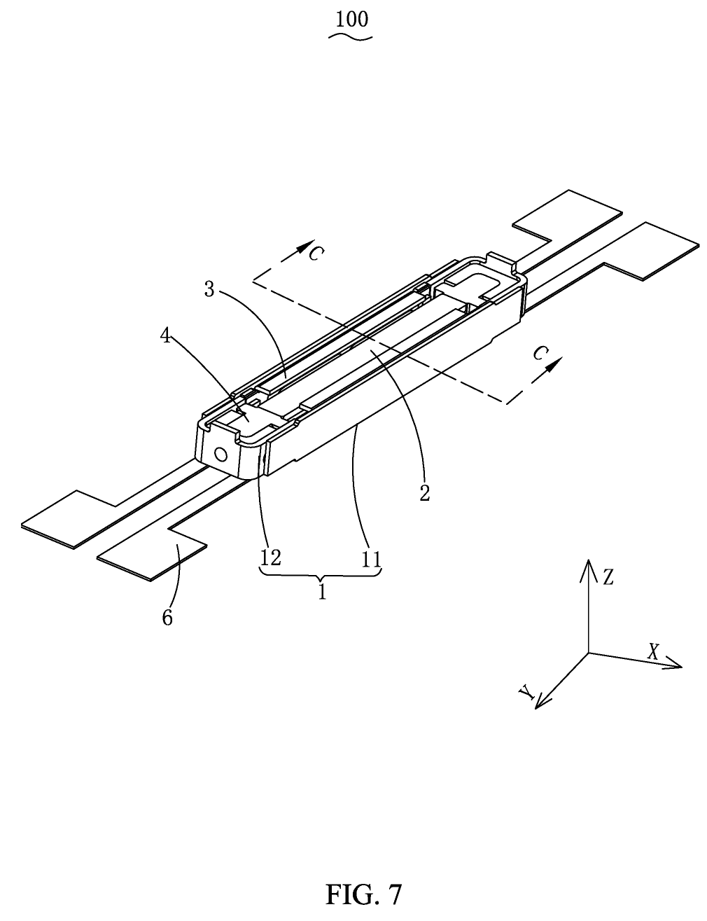

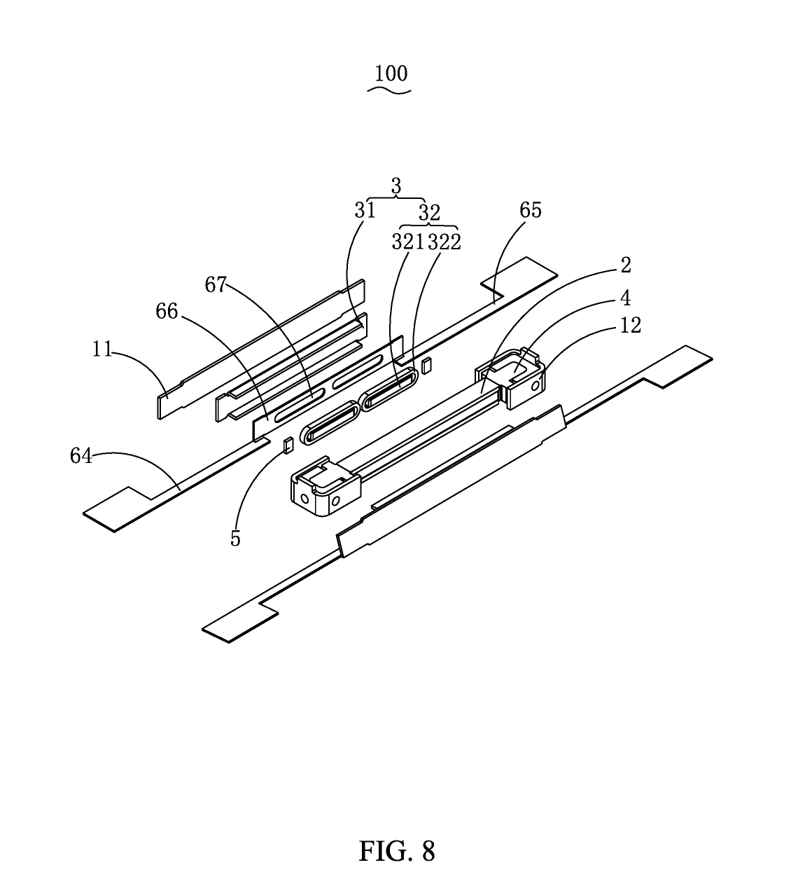

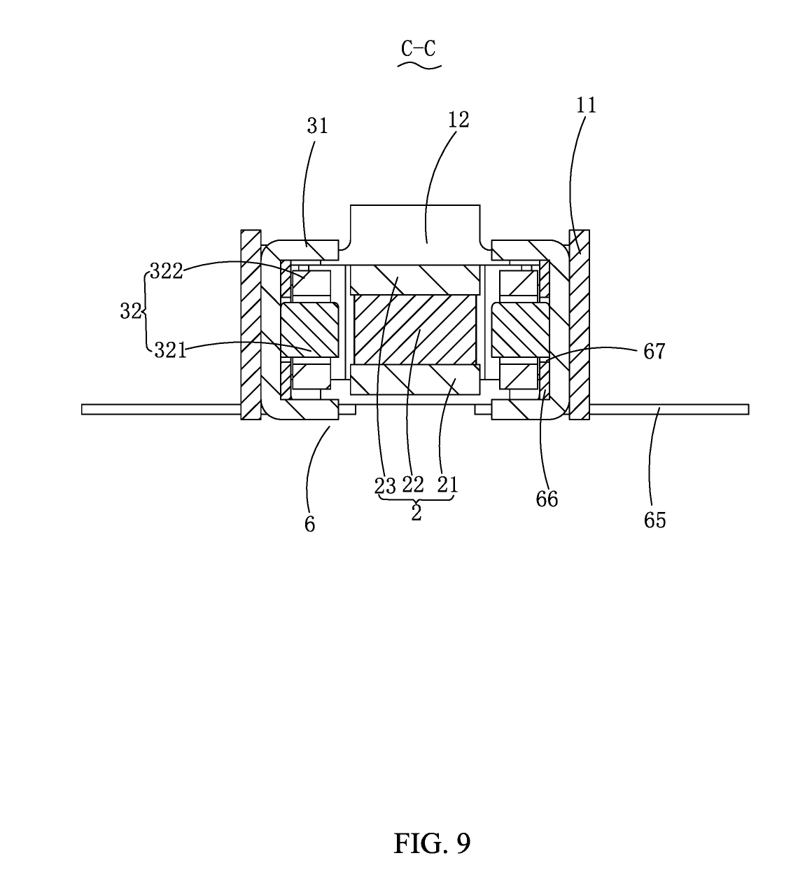

Referring to FIGS. 1 to 9, the second embodiment of the present disclosure is substantially identical to the first embodiment, with the differences residing in that: in this embodiment, each stator assembly 3 includes at least two stator units 32 arranged side by side in the third direction. The first direction, the second direction, and the third direction are mutually perpendicular to each other. A quantity of the motor drive amplifier units is consistent with (i.e. equal to) a quantity of the stator units 32, and each motor drive amplifier unit drives the drive coil 322 of one of the stator units 32. The motor drive amplifier units are in one-to-one correspondence with the two stator units 32, and configured to respectively drive the two drive coils 322 of the two stator units 32, thereby enabling independent motor drive amplifier units to drive corresponding drive coils 322, increasing motor drive power and enhancing output vibration feedback. The third direction is defined as the Y-axis direction.

In this embodiment, the flexible circuit board 6 includes a first circuit board 64 and a second circuit board 65 oppositely disposed in the third direction, a third circuit board 66 connecting the first circuit board 64 and the second circuit board 65, and at least two avoidance holes 67 penetrating through the third circuit board 66 and spaced apart along the third direction. An end of each of the first circuit board 64 and the second circuit board 65 away from the stator units 32 is configured to connect to the external power source, and the third circuit board 66 is stacked and fixed to a side of the pole core 31 close to the vibrator assembly 2. An iron core 321 of each stator unit 32 passes through one of the avoidance holes 67 and is fixed to the pole core 31, and the drive coil 322 of each stator unit 32 is stacked and fixed to a side of the third circuit board 66 adjacent to the vibrator assembly 2. An inner peripheral side of each drive coil 322 directly faces a corresponding one of the avoidance holes 67.

In this embodiment, the Hall sensors 5 are fixed to the flexible circuit board 6, and a quantity of the Hall sensors 5 is consistent with (i.e. equal to) a quantity of the stator units 32. The two Hall sensors 5 are spaced apart and respectively fixed to a side of the third circuit board 66 close to the vibrator assembly 2, one of the Hall sensors 5 is disposed adjacent to a side of the first circuit board 64, and the other Hall sensor 5 is disposed adjacent to a side of the second circuit board 65. By respectively mounting the two Hall sensors 5 on the first circuit board 64 and the second circuit board 65, each stator assembly 3 is provided with at least two stator units 32, such that each stator assembly 3 includes at least two drive coils 322. Through corresponding arrangement of at least two motor drive amplifier units to achieve one-to-one driving, a four-amplifier driving configuration is thereby realized, resulting in enhanced driving force.

Optionally, a quantity of the drive coils 322 is not limited to two but may be multiple, while requiring corresponding motor drive amplifier units to achieve a multi-amplifier driving effect.

Compared with related technologies, in the key motor system of the present disclosure, by arranging the vibrator assembly and the stator assemblies in the housing, the spatial occupation of the device is further reduced without affecting the overall spatial layout. The stator assemblies are disposed apart from the vibrator assembly and configured to drive the vibrator assembly to vibrate in the first direction, and the stator assemblies are designated as two and disposed on opposite sides of the vibrator assembly in the second direction. The two stator assemblies each has a side away from the vibrator assembly respectively fixed to the housing, and the second direction is perpendicular to the first direction. Each stator assembly includes a stator unit. The stator unit includes an iron core stacked and fixed to the housing and a drive coil. The drive coil is wound around the iron core. The motor drive amplifier units are designated as two, each motor drive amplifier unit driving the drive coil of one stator unit, thereby enabling one-to-one correspondence between the motor drive amplifier units and the drive coils to increase total driving force by enhancing driving power, enhancing output vibration feedback and optimizing user experience.

It will be understood that, although the terms first, second, etc., are, in some instances, used herein to describe various elements, these elements should not be limited by these terms. These terms are only used to distinguish one element from another. For example, a first fixing hole could be termed a second fixing hole , and, similarly, a second fixing hole could be termed a first fixing hole, without departing from the scope of the various described embodiments. The first widget and the second widget are both widget, but they are not the same condition unless explicitly stated as such.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The foregoing description, for purpose of explanation, has been described with reference to specific embodiments. However, the illustrative discussions above are not intended to be exhaustive or to limit the scope of the claims to the precise forms disclosed. Many modifications and variations are possible in view of the above teachings. The embodiments were chosen in order to best explain the principles underlying the claims and their practical applications, to thereby enable others skilled in the art to best use the embodiments with various modifications as are suited to the particular uses contemplated.

What is claimed is:

1. A key motor system, comprising:
a housing, being of a hollow structure;
a vibrator assembly, elastically supported in the housing;
two stator assemblies configured to drive the vibrator assembly to vibrate in a first direction and spaced apart from the vibrator assembly, wherein the two stator assemblies are disposed on opposite sides of the vibrator assembly in a second direction, a side of each of the two stator assemblies away from the vibrator assembly is fixed to the housing, the second direction is perpendicular to the first direction; each of the two stator assemblies comprises a stator unit, the stator unit comprises an iron core fixed to the housing and a drive coil, and the drive coil is wound around the iron core; and
at least two motor drive power amplifier units, wherein each of the at least two motor drive power amplifier units is configured to drive the drive coil of one of the stator units.

2. The key motor system according to claim 1, wherein each of the two stator assemblies further comprises a pole core, and the pole core is clamped and fixed between a corresponding one of the stator units and the housing.

3. The key motor system according to claim 2, wherein the key motor system further comprises Hall sensors, each of the Hall sensors is fixed on a side of the pole core close to the vibrator assembly, and the Hall sensors are configured to collect motion data of the vibrator assembly and send the motion data to the motor drive power amplifier units.

4. The key motor system according to claim 3, wherein the key motor system further comprises flexible circuit boards, an end of each of the flexible circuit boards away from the vibrator assembly is configured to connect to an external power source, an end of each of the flexible circuit boards close to the vibrator assembly is fixed to the pole core; each of the Hall sensors is mounted on a corresponding one of the flexible circuit boards, and each of the flexible circuit boards is electrically connected to the corresponding Hall sensor and drive coil.

5. The key motor system according to claim 4, wherein each of the flexible circuit boards comprises a circuit board body, a power connection portion extending from the circuit board body in a direction away from the housing, and a connection portion bent and extending from an end of the circuit board body close to the vibrator assembly in the first direction; the power connection portion is configured to connect to the external power source, the connection portion is fixed on a side of the pole core close to the vibrator assembly, and the Hall sensor is fixed to the connection portion.

6. The key motor system according to claim 4, wherein each of the two stator assemblies comprises at least two stator units arranged side by side in a third direction; the first direction, the second direction, and the third direction are mutually perpendicular to each other; a quantity of the motor drive power amplifier units is consistent with a quantity of the stator units, and each of the motor drive power amplifier units is configured to drive the drive coil of one of the stator units.

7. The key motor system according to claim 6, wherein the flexible circuit board comprises a first circuit board and a second circuit board oppositely disposed in the third direction, a third circuit board connecting the first circuit board and the second circuit board, and at least two avoidance holes penetrating through the third circuit board and spaced apart in the third direction, an end of each of the first circuit board and the second circuit board away from the stator unit is configured to connect to an external power source; the third circuit board is stacked and fixed to a side of the pole core close to the vibrator assembly; the iron core of each stator unit passes through one of the avoidance holes and is fixed to the pole core; the drive coil of each stator unit is stacked and fixed to a side of the third circuit board close to the vibrator assembly;
the Hall sensors are fixed to the flexible circuit boards, and a quantity of the Hall sensors is consistent with the quantity of the stator units.

8. The key motor system according to claim 6, wherein the house comprises two outer shells spaced apart from each other in the second direction, and two end covers spaced apart from each other in the third direction, the outer shells are fixed to a side of the stator assembly away from the vibrator assembly, and the vibrator assembly is elastically supported between the two end covers.

9. The key motor system according to claim 8, wherein the key motor system further includes two elastic components, an end of each of the elastic components away from the vibrator assembly is fixed to the end cover; and an end of teach elastic component close to the vibrator assembly are respectively fixed to opposite ends of the vibrator assembly in the third direction.

10. The key motor system according to claim 9, wherein the elastic component comprises a non-metallic elastic member fixed to a side of the end cover close to the vibrator assembly, and a connector member fixed to a side of the non-metallic elastic member close to the vibrator assembly; and a side of the connector member away from the end cover is fixed to the vibrator assembly.
